(19) United States
(12) Patent Application Publication
(10) Pub. No.: US 2007/0225876 A1
(43) Pub. Date: Sep. 27, 2007

(54) Method of Changing the Approach Procedure of an Aircraft

(75) Inventors: Christophe Caillaud, Blagnac (FR); Guy Deker, Cugnaux (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY-SUR-SEINE (FR)

(21) Appl. No.: 11/571,484

(22) PCT Filed: Jun. 28, 2005
(86) PCT No.: PCT/EP05/53022

§ 371 Date: Dec. 29, 2006

(30) Foreign Application Priority Data
Jun. 29, 2004 (FR) 04/07154

(51) Int. Cl. G05D 1/06

(52) U.S. Cl. 701/16

(57) ABSTRACT

The invention relates to a method of changing the approach procedure of an aircraft comprising steps of selecting a new landing runway of the destination airport and of selecting a landing aid system or non-precision approach procedure associated with this runway. The selection steps comprise an automatic selection of a pair associating the new landing runway with the landing aid system or with the non-precision approach procedure, the pair originating from a database containing the pairs related to the destination airport.

### CROSS REFERENCE TO RELATED APPLICATIONS

The present Application is based on International Application No. PCT/EP2005/053022, filed on Jun. 28, 2005, which in turn corresponds to FRANCE Application No. 04/07154, filed Jun. 29, 2004 and priority is hereby claimed under 35 USC §119 based on these applications. Each of these applications is hereby incorporated by reference in their entirety into the present application.

### FIELD OF THE INVENTION

The invention relates to aircraft navigation aid in the approach phase, in particular during a fast change of landing runway or procedure.

### BACKGROUND OF THE INVENTION

In most cases, an aircraft is equipped with a flight management computer FMS (the acronym standing for Flight Management System) which aids the pilot, especially in his management of the approach phase. The pilot programs an arrival procedure into his flight plan; said procedure includes the list of lateral segments, the constraints of the flight plan, a landing runway and the associated landing aid system or an approach procedure. As landing aid system may be cited systems comprising ground radio-navigation means such as ILS “Instrument Landing System”, VOR (VHF Omni Range), NDB (Non Directional Beacon) ground beacons etc to which there correspond sensors on board the aircraft. When no landing aid system is used, the runway is associated with a non-precision approach procedure such as the RNAV procedure (FMS surface navigation non-precision approach)

Illustrated in FIG. 1 is a lateral approach trajectory: it is situated between the end of a standard arrival trajectory STAR (the acronym standing for the expression Standard Terminal Arrival Route) and a landing runway 1. The STAR trajectory initiates the transition from cruising 3 to arrival. Each trajectory is established by the FMS on the basis of a procedure consisting of waypoints 7 linked by segments 9 and on the basis of transitions 5 calculated by the FMS to link the segments together.

There are generally several STARs which correspond to the various aircraft arrival sectors. Likewise, with each runway are associated several approach procedures pre-programmed as a function of the landing aid systems used (with each of these aid systems there corresponds one or more approach procedures as a function of the capabilities and limitations). Thus, each STAR arrival procedure can be tied (possibly through a transition 5) to several approach procedures as a function of the runway, of the direction of landing on the runway and of the chosen landing aid system. There may also exist a transition 5 for linking each approach procedure to the runway. Thus an arrival sector determines the STAR trajectory to be used while the choice of the approach procedure is determined by the air traffic controller or the pilot as a function of the direction of the runway in service as well as of the chosen landing aid system.

A runway is tagged by its orientation indicated in tens of degrees, and possibly by a letter L, R or C (such as “Left”, “Right” or “Central”) in the case of parallel runways. In what follows, the term runway designates a runway and its landing direction; thus in the figure, 4 parallel runways are represented, the runways 26R, 26L, 08L and 08R. Also represented in this figure is a radio-electric beam 11 for guidance by ILS beacons.

In certain cases, the air traffic controller requests the pilot to change landing runway because for example of a change of direction of the wind or of an offloading of the traffic on another runway, although the approach phase has already began. The pilot must then manually reprogram his flight plan, that is to say enter the new runway (for example runway 08L instead of 26L as illustrated in FIG. 1), choose the landing aid system associated with this new runway, and verify that the lateral approach trajectory and the vertical profile between the current position of the aircraft and the runway are correct. This reprogramming which for the pilot involves tapping various different buttons may be prohibitive in view of his workload during the approach phase.

As a function of the position of the aircraft, it is not always necessary to resume the whole of the new approach trajectory. This may necessitate deleting certain waypoints but this deletion must be negotiated with the air traffic controller, thereby significantly increasing the workload that may be prejudicial to the efficacity or even to the safety of the landing.

Now, when the approach phase has already begun, the pilot has only very little time to reprogram the corresponding new flight plan.

The most important aim of the invention is therefore to accelerate the change of runway before landing or more generally the change of approach, by facilitating and minimizing the actions of the pilot.

### SUMMARY OF THE INVENTION

To achieve this aim, the invention proposes a method of changing the approach procedure of an aircraft comprising steps of selecting a new landing runway of the destination airport and of selecting a landing aid system or non-precision approach procedure associated with this runway, principally characterized in that the selection steps comprise an automatic selection of a pair associating the new landing runway with the landing aid system or with the non-precision approach procedure, the pair originating from a database containing the pairs related to the destination airport.

This method allows the pilot to rapidly change runway before landing while minimizing his actions. It makes it possible to rapidly replace the trajectory initially scheduled by a trajectory for rejoining the axis of the runway and the runway itself with automatic selection of the landing aid system or of the non-precision approach procedure.

The selection of the pair consists in displaying on a man/machine interface, a set of pairs, and in validating by means of a command, the pair selected.

According to a characteristic of the invention, it comprises of step of command of the display by means of a man/machine interface.

Thus, a new function is available to the pilot allowing him to instruct the displaying of the pairs of the destination airport by means of a pilot interface.

According to an embodiment of the invention, the selection of the pair consists in displaying on an interface intended for the crew a first pair originating from the database, in scrolling through the pairs for as long as the pair to be selected is not displayed, and in validating by means of a command, the pair selected when it is displayed.

Preferably, it comprises prior to the step of selecting the pair, a step of pre-selecting pairs as a function of the availability of the landing aid systems.

According to a characteristic of the invention, the selection of the pair consists moreover in commanding a step of automatic calculation of a flight plan modified as a function of this selected pair, and of calculation of the approach trajectory on the basis of this modified flight plan, and a step of automatic displaying of the approach trajectory and of the runway.

The invention also relates to a navigation aid system comprising an onboard flight management computer, characterized in that it comprises, linked to the computer, a database consisting of pairs which on each occasion associate a landing runway and a landing aid system or a non-precision approach procedure, means of displaying the pairs and means of selecting a pair.

According to a characteristic of the invention, it comprises, linked to the computer, a man/machine interface comprising the means of displaying the pairs and the means of selecting a pair and preferably means of command of the displaying of the pairs.

The man/machine interface is equipped with a selector able to scroll through the pairs on the interface and to select a pair. This selector is a button with two concentric selections, accompanied by a command for respectively selecting and validating the pair.

According to a characteristic of the invention, the computer comprises means of computing a modified flight plan as a function of the pair selected.

Still other advantages of embodiments according to the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### BRIEF DESCRIPTION OF THE DRAWINGS

Other characteristics and advantages of the invention will become apparent on reading the detailed description which follows, given by way of nonlimiting example and with reference to the appended drawings in which:

FIG. 1 diagrammatically illustrates a change of approach trajectory,

FIG. 2 diagrammatically represents an FMS computer linked to various items of equipment,

FIG. 3 diagrammatically represents an exemplary approach page,

FIG. 4 diagrammatically represents an exemplary page for selecting a pair,

FIG. 5 diagrammatically represents an exemplary means of selecting a pair,

FIG. 6 diagrammatically represents examples of pairs of a database, presented in the form of a stack,

FIG. 7 diagrammatically represents an exemplary new approach trajectory.

### DETAILED DESCRIPTION OF ILLUSTRATIVE EMBODIMENTS

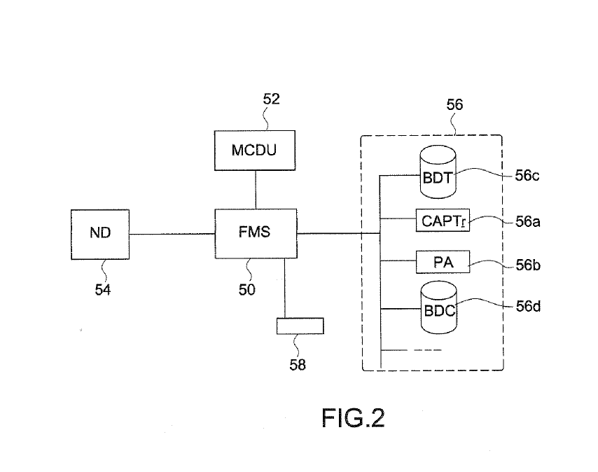

An aircraft is equipped with a flight management computer FMS (the acronym standing for the expression Flight Management System). As represented in FIG. 2, the FMS computer 50 is linked at least to a man/machine interface for example an MCDU 52 (the acronym standing for the expression Multi Purpose Control and Display Unit) termed a “head-down” interface, to a navigation screen ND 54 (the acronym standing for the expression Navigation Display), to various items of onboard equipment 56 (sensors 56a, automatic pilot 56b, terrain database 56c, etc). This interface comprises a display screen associated with a selection device allowing the pilot to verify, to select and/or to modify certain fields displayed.

The method according to the invention allows the pilot to rapidly change runway before landing while minimizing his actions. It makes it possible to rapidly replace the trajectory initially scheduled by a trajectory for rejoining the axis of the runway and the runway itself with automatic selection of the landing aid system.

The method consists in particular in displaying, selecting and programming the new runway as well as the most appropriate landing aid system, by means of a user-friendly and intuitive pilot interface.

According to the invention, an airport runway, associated with a landing aid system constitutes a pair. A runway may be associated with several landing aid systems, by being for example equipped with several types of beacons. In this case, several pairs comprise the same runway but are distinguished from one another by the landing aid system or the non-precision approach procedure. Examples of pairs are presented in FIGS. 4 and 5.

All of the pairs of the destination airport are stored in a database 56d. This database linked to the FMS computer also comprises all the pairs of other airports.

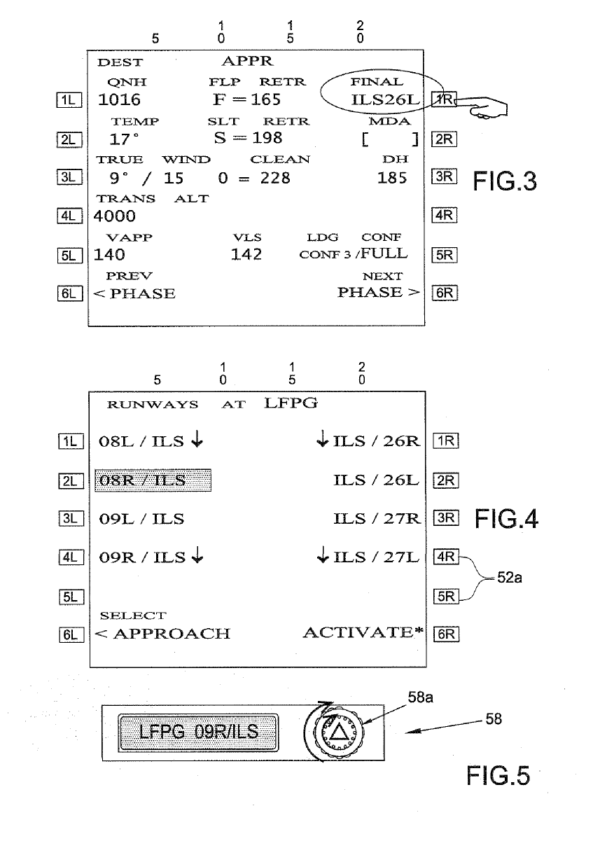

The method according to the invention intervenes in the approach phase, while an approach page such as represented in FIG. 3, is displayed in regulatory fashion on the man/machine interface 52. On this interface appears the active pair, that is say as initially scheduled, before the change.

When a change of runway is requested by the air traffic controller, the pilot can then directly modify the pair selected by entering into the corresponding field the new runway, as well as one of the landing aid systems or a non-precision approach procedure associated with the runway, of his choice.

For practical reasons, as was seen in the preamble, given the pilot's load during the approach phase, the tapping of several different buttons of the alphabetical keypad may be prohibitive.

According to the invention, a new function is available to the pilot allowing him to command the displaying of the pairs of the destination airport by means of a pilot interface.

More precisely, the FMS allows the crew the prior displaying on an interface intended for them of all the existing pairs for the destination in progress. This display is initiated by the pilot calling the function associated with the rapid change of runways.

The pilot must thereafter validate his selection so that the new approach corresponding to this new pair is handled by the onboard systems. This validation of the selected pair is performed by means of a command dependent on the interface used.

The activation of the function may be carried out by two different and complementary means, one being accessible through the head-down interface of the FMS (for example the MCDU), the other through a so-called “head-up” pilot interface, vis the FCU selection banner 58 also linked to the FMS as illustrated in FIG. 5.

According to a first embodiment, the command of the display is implemented by means of the MCDU interface. For this purpose it selects the field of the initially scheduled runway, as indicated in the example (ILS26L) approach page of FIG. 3, by means for example of the corresponding line key (1R).

This display command has the effect of displaying a summary page of all the pairs of the destination airport, for example on this MCDU interface, as illustrated on the screen page represented in FIG. 4. This page presents the 8 runways of the CDG de Roissy airport in France, which are respectively associated with a landing aid system, in this instance the ILS system. The arrow symbol indicates that several landing aid systems are available on the corresponding runway; such is the case for the runways 08L, 09R, 26R and 27L since they are also equipped with a VOR system.

The pilot then validates the pair selected, by means of the selection device which may be a line key 52a as indicated in the figure. This way of selecting a pair on the basis of a line key of the MCDU interface 50 is ergonomic, this being advantageous in an environment where the workload of the pilot is high.

The “Select Approach” button also displayed on this page remains available to the pilot when the latter wishes to access the customary page for programming the arrival procedure. This page is more complete since it comprises all the arrival procedures for the destination airport but induces actions which are more unwieldy in terms of workload and attention.

According to another embodiment, the displaying of the pair in progress (before change) and the possible selecting of another pair by the pilot are proposed on a pilot interface 58 also linked to the FMS, for example on a screen in the form of a banner as illustrated in FIG. 5.

This selection is proposed to the pilot by way of a dropdown menu (continuous stack) which displays all the pairs that the pilot can scroll through by means of a command.

As long as the desired pair has not been displayed, the pilot can scroll through the pairs apt to be selected by means of a selector. Once the desired pair has been displayed, the pilot validates this selection by means of another command.

This selection may be accelerated using a selector with two selections. The selector and this other command are for example grouped together in a knob 58a. This is for example a knob with two concentric selections, that are indicated in the figure by two arrows, allowing the pairs to be scrolled through, one so as to scroll through the runways, the other so as to scroll through the landing aid systems associated with the runway. The validation of this selection is carried out by an action on this same knob (for example by a push action).

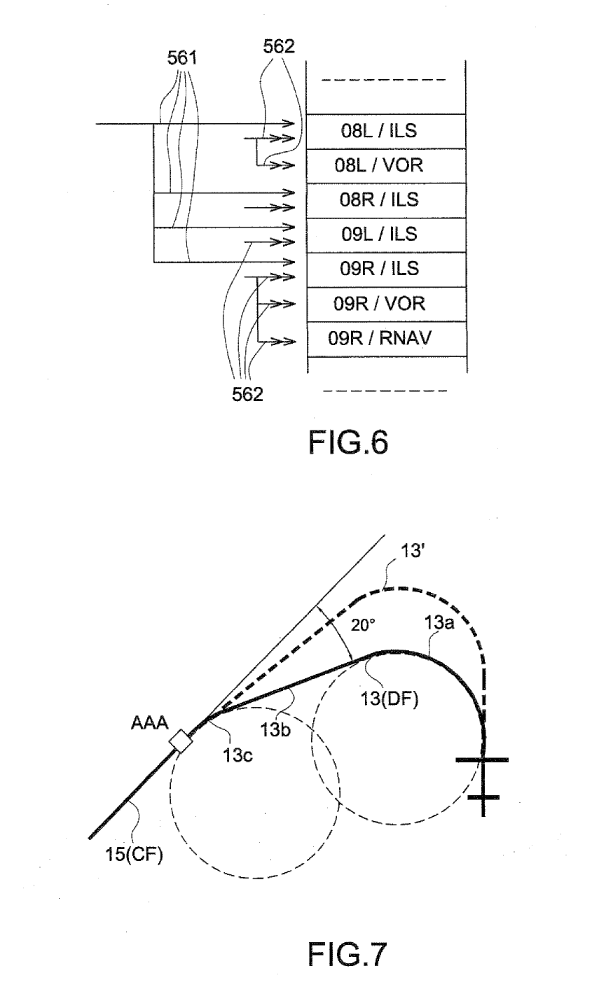

The selections correspond respectively to a first and a second pointer in the database of pairs, as illustrated in FIG. 6. For simplicity the pairs of the database are represented in the form of an ordered stack of pairs. The first location is that of a first runway associated with a landing aid system, in this instance 08L/ILS; the second location is that of the same runway associated with another landing aid system in this instance 08L/VOR; the third and fourth locations are respectively those of a second and third runway associated with a single landing aid system, in this instance 08R/ILS and 09L/ILS; the fifth and sixth locations are respectively those of a fourth runway respectively associated with a first and second landing aid system in this instance 09R/ILS and 09R/VOR; etc. The pairs comprising the same runway form a subset. The first pointer 561 points only at the first location of a subset, whereas the second pointer 562 points only at the locations of the subset that is already pointed at by the first pointer.

Represented in FIG. 2 are the two pilot interfaces 52 and 58; the interface 58 is not necessary for the first embodiment.

Whether it be either embodiment, the runway being imposed by the air traffic controller, or even by the pilot himself, the pilot selects the pair corresponding to this runway and to the landing aid system with which the aircraft is equipped. If several landing aid systems are available to him, he chooses the most beneficial at the operational level. This is for example the one which is most precise for “all-weather” landings, the trickiest configuration for a pilot, the most demanding in terms of category (e.g.: ILS CAT III) which becomes the preferred approach for which the pilot actions must be as restricted as possible.

According to a variant of the invention, the FMS proposes by default as first pair of a subset, that whose landing aid system is the most precise, the ILS for example, as illustrated in FIG. 4.

Preferably, the pairs displayed have formed the subject of a preselection by the FMS: these are the pairs apt to be selected, that is to say those whose landing aid system can be implemented since the aircraft and the airport are equipped with corresponding means or those comprising an available approach procedure.

This selection aid is accompanied by a new optimized computation of the trajectory, both lateral and vertical, making it possible to present the aircraft within the best safety and comfort conditions and in compliance with the regulations (compliance with the navigation constraints).

The selecting of the pair has the effect of automatically commanding the computation by the FMS computer, of a new flight plan modified as a function of the new pair selected; it also commands the displaying on the ND screen, of the runway and of the approach trajectory corresponding to this new flight plan and computed by the FMS, and preferably the displaying on the man machine interface (for example an MCDU) of the conditions of the new approach procedure (exact heading of the runway, parameters related to the landing aid system, etc.).

The flight plan is drawn up taking account of the speed profile and altitude profile necessary for approach and for landing. As long as the new flight plan has not been validated by the pilot, the runway and the approach trajectory are displayed with a code, for example a color code, indicating that this is a temporary selection.

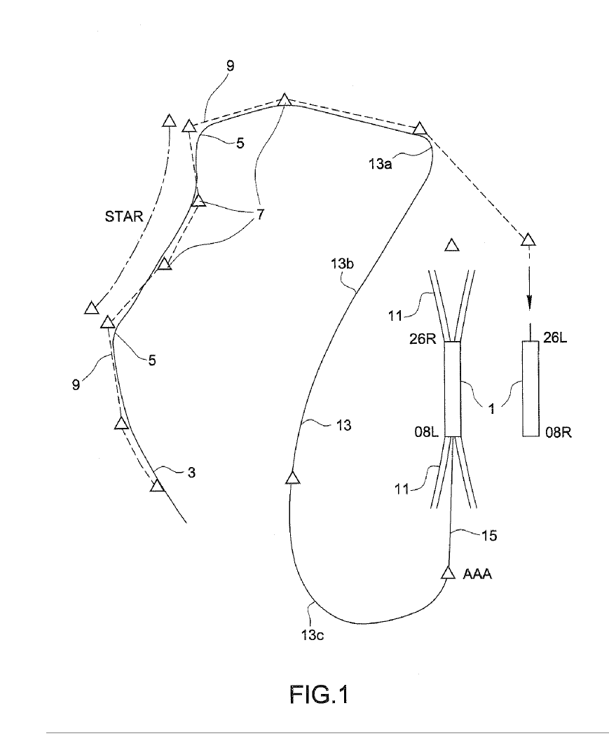

The new flight plan computed by the FMS comprises for example two lateral segments, as illustrated in FIGS. 1 and 7.

A first segment 13 joining the current position of the aircraft to a point AAA making it possible to intercept the axis of the runway 1; this segment is of the DF “Direct to Fix” type, that is to say a type of segment standardized by the ARINC 424 standard corresponding to a direct trajectory towards a turning point, with an additional characteristic of interception of the axis of the runway; in the general case, this segment consists of a first bank 13a, of a straight trajectory 13b followed by a last bank 13c.

A second segment 15 joining the point AAA to the threshold of the runway itself; this segment is of the CF “Course to Fix” type, that is to say a type of segment standardized by the ARINC 424 standard corresponding to a maintaining of angle of course towards a point, with the course corresponding to the orientation of the runway.

The segment 13 of DF type is computed in such a way as to reduce the maneuvers and the distance. The computation takes account:

a) of the maximum angle of roll that the aircraft will envisage for optimizing the time and radius of banking but will not exceed for passenger safety and comfort reasons,

b) of the distance required for instigating banking of the aircraft to create the corresponding straight trajectory 13b, before the bank 13c,

c) of the current ground speed and of the scheduled angle of roll of the aircraft during the first bank 13a, (itself dependent on a possible transition trajectory and on the maximum angle of roll) to calculate the banking radius of this possible 1st bank and construct it if necessary,

d) of the groundspeed scheduled at the point AAA and of the scheduled angle of roll of the aircraft, to calculate the banking radius of the possible last bank 13c and construct it if necessary,

e) of the chaining with a segment of CF type which requires that the DF segment be terminated with the track of the following CF segment,

f) of the fact that the distance up to the point AAA is the shortest possible and that it allows the aircraft to decelerate from its current speed down to the landing speed.

In the case of a landing aid system of LOC type (the abbreviation standing for the expression “Localizer”) or ILS type, there exists an additional constraint g) which requires the choice of a lateral trajectory of interception of the runway axis with a relatively small angle preferably less than around 20°.

When the constraints e), f) or g) cannot be complied with, the FMS computer proposes another segment 13′ of the length necessary to comply with these constraints, as illustrated in FIG. 7.

Once these lateral segments have been determined the FMS computer computes a vertical trajectory allowing the aircraft to intercept under good passenger safety and comfort conditions, the final vertical axis. This trajectory generally consists in holding a plateau until a descent initiation point calculated to intercept the final axis without deviating from the lateral trajectory (without “overshoot”).

The vertical trajectory may optionally include a climb segment allowing the aircraft to reposition itself at a minimum altitude for intercepting the final axis. Such is the case for example when the approach to the previous runway was already properly engaged.

The lateral and vertical trajectories being computed, the FMS displays them on the ND screen. It also activates the selected landing aid system by sending the sensor of the aircraft the frequency of the associated ground beacon.

The pilot can then validate the new flight plan by means for example of a button of “activate” type of the MCDU, such as represented in FIG. 4. The flight plan is then activated.

This results in a displaying of the trajectories indicating that the corresponding flight plan is active and no longer temporary, for example by means of a specific color code. The landing aid system is armed by the pilot and as soon as the conditions of capture and of tracking according to the landing system are satisfied, the FMS authorizes the automatic pilot to engage the approach phase.

Moreover, as soon as the new flight plan is validated, the landing runway can no longer be “sequenced”, that is to say deleted from the flight plan; likewise the selection of the landing aid system or of the approach procedure is retained.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A method of changing an approach procedure of an aircraft comprising the steps of:
selecting a new landing runaway of the destination airport;
selecting a landing aid system or non-precision approach procedure associated with this runway;
automatically selecting a pair associating the new landing runway with the landing aid system or with the non-precision approach procedure, the pair originating from a database including the pairs related to the destination airport.

2. The method changing approach procedure as claimed in claim 1, wherein the landing aid system is predetermined by default.

3. The method changing approach procedure as claimed in claim 1 wherein the selection of the pair consists in displaying on a man/machine interface, a set of pairs, and in validating by means of a command, the pair selected.

4. The method of changing approach procedure as claimed in claim 3, wherein comprises of step of command of the display by means of a man/machine interface.

5. The method of changing approach procedure as claimed in claim 1, wherein the selection of the pair consists in displaying on an interface intended for the crew a first pair originating from the database, in scrolling through the pairs for as long as the pair to be selected is not displayed, and in validating by means of a command, the pair selected when it is displayed.

6. The method of changing approach procedure as claimed in claim 3, wherein it comprises prior to the step of selecting the pair, a step of pre-selecting pairs as a function of the availability of the landing aid system or of the non-precision approach procedures.

7. The method of changing approach procedure as claimed in claim 3, wherein the selection of the pair consists moreover in commanding a step of automatic calculation of a flight plan modified as a function of this selected pair, and of calculation of the approach trajectory on the basis of this modified flight plan, and a step of automatic displaying of the approach trajectory and the runway.

8. The method of changing approach procedure as claimed in claim 7, wherein the calculation of the modified flight plan comprises a step of determining a first segment joining the current position of the aircraft to a point AAA making it possible to intercept the axis of the runway, this segment comprising a first bank, a direct trajectory and a last bank, and of a second segment joining the point AAA to the threshold of the runway itself, this corresponding to a maintaining of angle of course to a point, with the course corresponding to the orientation of the runway.

9. The method of changing approach procedure as claimed in claim 8, wherein the first segment is determined as a function
of a maximum angle of roll of the aircraft,
of the distance required for banking the aircraft,
of the current ground speed, of the ground speed scheduled at the point AAA and of the scheduled angle of roll of the aircraft while banking,
of the chaining with the second segment,
of the fact that the distance up to the point AAA is the shortest possible and it allows the aircraft to decelerate from its current speed down to its landing speed.

10. The method of changing approach procedure as claimed in claim 7, wherein the calculation of the modified flight plan comprises a step of determining a vertical trajectory comprising a plateau up to a descent initiation point calculated so as to intercept a final axis without deviating from the lateral trajectory.

11. The method of changing approach procedure as claimed in claim 10, wherein the vertical trajectory includes a climb segment allowing the aircraft to reposition itself at a minimum altitude so as to intercept the final axis.

12. The method of changing approach procedure as claimed in claim 7, comprising a step of validation and of activation of the flight plan.

13. A navigation aid system comprising an onboard flight management computer, said database comprising, a database linked to the computer consisting of pairs which on each occasion associate a landing runway and a landing aid system or a non-precision approach procedure, means of displaying the pairs and means of selecting a pair.

14. The navigation aid system as claimed in claim 13, comprising a man/machine interface linked to the computer comprising the means of displaying the pairs and the means of selecting a pair.

15. The navigation aid system as claimed in claim 14, wherein the man/machine interface furthermore comprises means of command of the displaying of the pairs.

16. The navigation aid system as claimed in claim 13, wherein the man/machine interface is equipped with a selector able to scroll through the pairs on the interface and to select a pair.

17. The navigation aid system as claimed in claim 16, wherein the selector is a bottom with two concentric selections, accompanied by a command for respectively selecting and validating the pair.

18. The navigation aid system as claimed in claim 13, wherein a computer comprises means of computing a modified flight plan as a function of the pair selected.

19. The method of changing approach procedure as claimed in claim 2, wherein the selection of the pair consists in displaying on a man/machine interface, a set of pairs, and in validating by means of a command, the pair selected.

20. The method of changing approach procedure as claimed in claim 2, wherein the selection of the pair consists in displaying on an interface intended for the crew a first pair originating from the database, in scrolling through the pairs for as long as the pair to be selected is not displayed, and in validating by means of a command, the pair selected when it is displayed.

21. The method of changing approach procedure as claimed in claim 2, wherein the selection of the pair consists in displaying on an interface intended for the crew a first pair originating from the database, in scrolling through the pairs for as long as the pair to be selected is not displayed, and in validating by means of a command, the pair selected when it is displayed.

22. The method of changing approach procedure as claimed in claim 4, wherein the selection of the pair consists in displaying on an interface intended for the crew a first pair originating from the database, in scrolling through the pairs for as long as the pair to be selected is not displayed, and in validating by means of a command, the pair selected when it is displayed.

23. The method of changing approach procedure as claimed in claim 8, wherein the calculation of the modified flight plan comprises a step of determining a vertical trajectory comprising a plateau up to a descent initiation point calculated so as to intercept a final axis without deviating from the lateral trajectory.

24. The method of changing approach procedure as claimed in claim 9, wherein the calculation of the modified flight plan comprises a step of determining a vertical trajectory comprising a plateau up to a descent initiation point calculated so as to intercept a final axis without deviating from the lateral trajectory.

25. The method of changing approach procedure as claimed in claim 23, wherein the vertical trajectory includes a climb segment allowing the aircraft to reposition itself at a minimum altitude so as to intercept the final axis.

26. The method of changing approach procedure as claimed in claim 24, wherein the vertical trajectory includes a climb segment allowing the aircraft to reposition itself at a minimum altitude so as to intercept the final axis.

27. The navigation aid system as claimed in claim 14, wherein the man/machine interface is equipped with a selector able to scroll through the pairs on the interface and to select a pair.

28. The navigation aid system as claimed in claim 15, wherein the man/machine interface is equipped with a selector able to scroll through the pairs on the interface and to select a pair.

29. The navigation aid system as claimed in claim 27, wherein the selector interface is a button with two concentric selections, accompanied by a command for respectively selecting and validating the pair.

30. The navigation aid system as claimed in claim 28, wherein the selector is a button with two concentric selections, accompanied by a command for respectively selecting and validating the pair.

31. The navigation aid system as claimed in claim 14, wherein a computer comprises means of computing a modified flight plan as a function of the pair selected.

32. The navigation aid system as claimed in claim 15, wherein a computer comprises means of computing a modified flight plan as a function of the pair selected.

33. The navigation aid system as claimed in claim 16, wherein a computer comprises means of computing a modified flight plan as a function of the pair selected.
